(19) United States
(12) Patent Application Publication
(10) Pub. No.: US 2022/0300382 A1
(43) Pub. Date: Sep. 22, 2022

(54) INFORMATION PROCESSING APPARATUS AND RESTORATION CONTROL METHOD

(71) Applicant: FUJITSU LIMITED, Kawasaki-shi (JP)

(72) Inventor: Satoshi Imamura, Kawasaki (JP)

(73) Assignee: FUJITSU LIMITED, Kawasaki-shi (JP)

(21) Appl. No.: 17/521,222

(22) Filed: Nov. 8, 2021

(30) Foreign Application Priority Data
Mar. 16, 2021 (JP) 2021-042904

(51) Int. Cl. G06F 11/14; G06F 11/34

(52) U.S. Cl. CPC G06F 11/1466; G06F 11/1469; G06F 11/3419

(57) ABSTRACT

An information processing apparatus including: a first storage device; a second storage device having lower performance than performance of the first storage device; and a control circuit configured to perform processing including: copying data from the first storage device to the second storage device to make the data persistent; estimating, based on statistical information acquirable by hardware, an overhead of a first restoration method in which the data is restored by copying the data from the second storage device to the first storage device and an overhead of a second restoration method in which the data in the second storage device is used as it is; and restoring the data that becomes persistent, based on a restoration method having a smaller overhead of the respective estimated overheads of the first restoration method and the second restoration method, when restoring the data.

### CROSS-REFERENCE TO RELATED APPLICATION

This application is based upon and claims the benefit of priority of the prior Japanese Patent Application No. 2021-42904, filed on Mar. 16, 2021, the entire contents of which are incorporated herein by reference.

### FIELD

The embodiments discussed herein are related to an information processing apparatus and a restoration control method.

### BACKGROUND

In recent years, a persistent memory (PMEM) has been used as a main storage device in the same manner as a dynamic random-access memory (DRAM). The PMEM has performance characteristics different from performance characteristics of the DRAM. For example, the PMEM has lower access performance than the DRAM, but has higher read performance than write performance. Although the access performance of the PMEM is lower than the DRAM, sequential access performance is higher than random access performance. In addition, the PMEM is a non-volatile memory in which data is not erased when power supply is cut off, and is used for persistence of the data.

For a computer including the DRAM and the PMEM, persistence and restoration for data using the PMEM are proposed. According to the persistence process, a target object obtained by combining target data with metadata is copied from the DRAM to the PMEM and is persistently stored. In the restoration process, information on the target object is re-registered in metadata for managing the object, and the persistent object is restored and reused.

As the restoration process, there are known a method of copying the object from the PMEM to the DRAM and re-registering the object in the object management metadata, and a method of re-registering the object in the PMEM in the object management metadata to be reused as it is. By a user designating the restoration method, the computer may execute the restoration process based on the designated restoration method. FIG. 11 is a reference diagram of a restoration process. As illustrated in FIG. 11, for example, a programmer designates a restoration method in a source code, and in a computer, a restoration function of a backend memory management function included in target software executes the restoration process on an object based on the designated restoration method.

Examples of the related art include as follows: Japanese Laid-open Patent Publication No. 2008-46964; and Japanese Laid-open Patent Publication No. 2019-45974.

### SUMMARY

According to an aspect of the embodiments, there is provided an information processing apparatus including: a control circuit; a first storage device; and a second storage device having lower performance than performance of the first storage device. In an example, the control circuit of the information processing apparatus is configured to perform processing, the processing including: copying data from the first storage device to the second storage device to make the data persistent; estimating, based on statistical information that is acquirable by hardware, an overhead of a first restoration method in which the data is restored by copying the data from the second storage device to the first storage device and an overhead of a second restoration method in which the data in the second storage device is used as it is; and restoring the data that becomes persistent, based on a restoration method having a smaller overhead of the respective estimated overheads of the first restoration method and the second restoration method, when restoring the data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a hardware configuration of an information processing apparatus according to an embodiment;

FIG. 2 is a block diagram illustrating an example of a functional configuration of the information processing apparatus according to the embodiment;

FIG. 3 illustrates an example of an overhead comparison;

FIG. 4 is a diagram describing a memory management function according to the embodiment;

FIG. 5 illustrates an example of a source code;

FIG. 6 illustrates an example of a persistence process according to the embodiment;

FIG. 7 illustrates an example of a restoration process according to the embodiment;

FIG. 8 illustrates an example of a flowchart of a statistical information acquisition process according to the embodiment;

FIG. 9 illustrates an example of a flowchart of a persistence process according to the embodiment;

FIG. 10 illustrates an example of a flowchart of a restoration process according to the embodiment; and

FIG. 11 is a reference diagram of the restoration process.

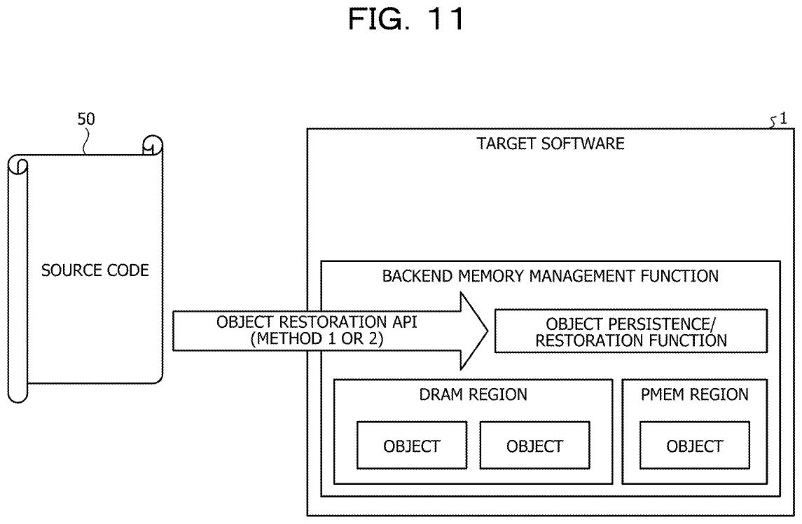

### DESCRIPTION OF EMBODIMENTS

Meanwhile, there is a problem that it is difficult to select an optimum restoration method to shorten a processing time of processes after restoration. A time period for copying the object from the PMEM to the DRAM is obtained by multiplying a size of the object by a throughput of sequential reading from the PMEM. The size of the object may be acquired from metadata of each object. The throughput of the sequential reading from the PMEM may be acquired by pre-measurement using a benchmark or by referring to specifications of the PMEM. Accordingly, the copy time of the object from the PMEM to the DRAM is easily obtained at a time of the restoration process.

By contrast, an increment execution time by an access in the PMEM with respect to an execution time by an access to the object in the DRAM after restoration depends on an access pattern for each object. The access pattern of the object may not be easily obtained in the restoration process.

Since the execution time period increased by the access in the PMEM is not easily obtained, even when a time period for copying the object from the PMEM to the DRAM is obtained, it is not possible to compare processing loads (overheads) of the respective methods. For example, an optimum restoration method may not be selected to shorten a processing time of processes after restoration.

In one aspect, an object of the present disclosure is to shorten a processing time of a process after restoration.

Hereinafter, embodiments of an information processing apparatus and a restoration control method disclosed in the present application will be described in detail with reference to the drawings. Note that the present disclosure is not limited to the embodiment.

### Embodiment

[Hardware Configuration of Information Processing Apparatus]

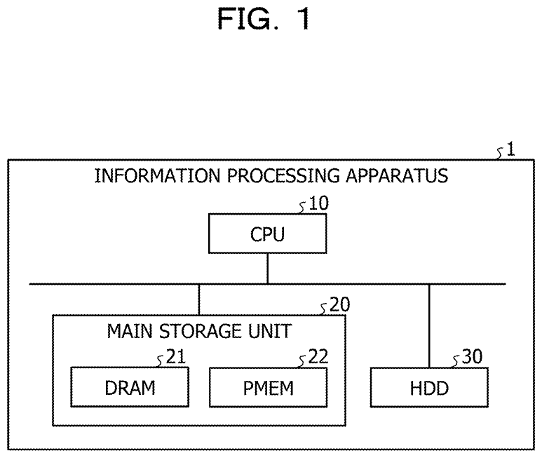

FIG. 1 illustrates an example of a hardware configuration of an information processing apparatus according to an embodiment. As illustrated in FIG. 1, an information processing apparatus 1 includes a central processing unit (CPU) 10, a main storage unit 20, and a hard disk drive (HDD) 30.

The CPU 10 is coupled to the main storage unit 20 and the HDD 30 by a bus. The main storage unit 20 includes a DRAM 21 and a PMEM 22. The PMEM 22 has a performance characteristic different from a performance characteristic of the DRAM 21. For example, the PMEM 22 has lower access performance than the DRAM, but has higher read performance than write performance. Although the PMEM 22 has lower access performance than the DRAM, sequential access performance is higher than random access performance. The PMEM 22 is a non-volatile memory in which data is not erased when power supply is cut off, and is used for persistence of the data.

The CPU 10 reads a program for operating an operating system (OS) and various applications from the hard disk drive (HDD) 30 and executes the program. The CPU 10 accesses the main storage unit 20 to read and write data when the application is executed, and reads the data from the main storage unit 20 and writes the data to the main storage unit 20.

When describing software as an operating entity, the application operated on the OS by the CPU 10 stores temporary data to be temporarily stored in a storage device in the DRAM 21. The application operated on the OS by the CPU 10 copies and stores, from the DRAM 21 to the PMEM 22, data requested to be continuously held even when power supply is stopped. The application that copies data from the DRAM 21 to the PMEM 22 and makes the data persistent is referred to as a “persistence process”, hereinafter.

The application operated on the OS by the CPU 10 re-registers information of the data in management metadata (not illustrated) held in the DRAM 21, and restores and reuses the persistent data. Hereinafter, an application that reuses the data is referred to as a “restoration process”. A restoration method includes a first restoration method in which data is copied from the PMEM 22 to the DRAM 21 and re-registered in management metadata, and a second restoration method in which the data in the PMEM 22 is re-registered in management metadata to be reused as it is.

In a case of being restored by the first restoration method, the CPU 10 copies data from the PMEM 22 to the DRAM 21 and re-registers the data in management metadata, and may access the data in the DRAM 21 at high speed after the restoration process. For example, in the first restoration method, a copy time from the PMEM 22 to the DRAM 21 is an overhead. By contrast, in a case where the restoration is performed by the second restoration method, the CPU 10 does not have to copy data from the PMEM 22 to the DRAM 21, and accesses the data from the PMEM 22 after the restoration process. For example, in the second restoration method, an access performance difference between the PMEM 22 and the DRAM 21 is an overhead.

An application for the restoration process operated on the OS by the CPU 10 selects a restoration method with a small overhead and executes the restoration process. Hereinafter, the information processing apparatus 1 that executes the restoration process with a small overhead will be described.

[Configuration of Information Processing Apparatus]

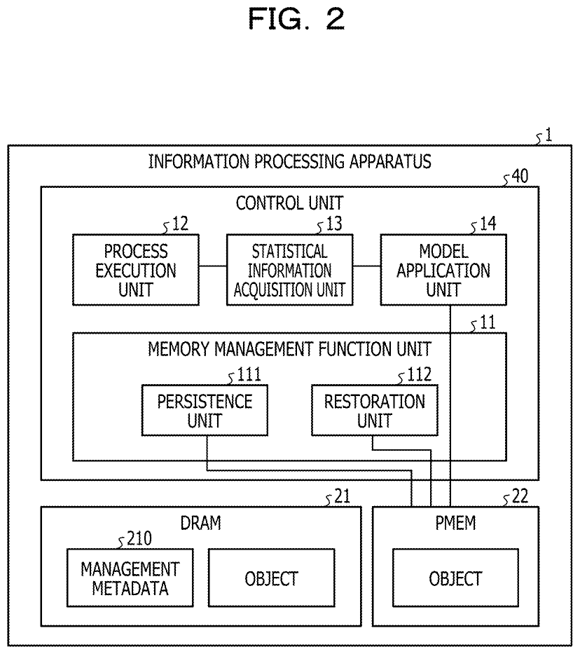

FIG. 2 is a block diagram illustrating an example of a functional configuration of the information processing apparatus according to the embodiment. As illustrated in FIG. 2, the information processing apparatus 1 includes a control unit 40, the DRAM 21, and the PMEM 22. The control unit 40 includes a memory management function unit 11, a process execution unit 12, a statistical information acquisition unit 13, and a model application unit 14. The control unit 40 is an example of a control unit. The DRAM 21 is an example of a first storage unit. The PMEM 22 is an example of a second storage unit.

The DRAM 21 includes management metadata 210 and an object. The object is information in which data is combined with metadata. The object is a target of a persistence process and a restoration process. The management metadata 210 is information for managing data as an object. For example, the management metadata 210 stores, for each object, an address indicating where each object is arranged in the DRAM 21 or the PMEM 22. Information (for example, an address) of the object is re-registered in the management metadata 210 in the restoration process.

The memory management function unit 11 performs the persistence process and the restoration process on the object by using the DRAM 21 and the PMEM 22. The memory management function unit 11 includes a persistence unit 111 and a restoration unit 112.

The persistence unit 111 copies a target object from the DRAM 21 to the PMEM 22 and makes the target object persistent. For example, the persistence unit 111 executes an API for the persistence process of the target object in a source code 50 coded by a programmer, and performs the persistence process. As an example, the source code 50 is a source code using a script language such as R or Python. By using the model application unit 14 which will be described below, the persistence unit 111 may include a process of determining and recording a restoration method for the target object.

The restoration unit 112 restores the persistent target object based on the restoration method with a smaller overhead among respective overheads of the first restoration method and the second restoration method. For example, the restoration unit 112 restores the target object by using the restoration method associated with the target object by the subsequent model application unit 14. The restoration method is stored in metadata of the target object.

The process execution unit 12 executes a process on the target object to acquire predetermined statistical information. For example, the process execution unit 12 executes the process on the target object from a start to an end of the acquisition of statistical information coded in the source code 50. Such an execution time is referred to as an “execution time in the DRAM 21”. The process execution unit 12 temporarily holds the execution time in the DRAM 21 in the DRAM 21, for example. The process on the object may be a process of reading from or writing to the target object held in the DRAM 21.

For the target object, the statistical information acquisition unit 13 acquires statistical information that is acquirable by hardware.

For example, the statistical information acquisition unit 13 acquires the statistical information that is acquirable by hardware when the process execution unit 12 executes the process on the target object. The statistical information that is acquirable by hardware means indexes related as characteristics of the PMEM 22, and includes an access frequency, a read/write ratio, and a sequential access/random access ratio. As an example, in order to calculate the access frequency, the statistical information acquisition unit 13 acquires the number of execution instructions, and the number of reads and the number of writes in the DRAM 21 from a hardware performance counter when the process is executed by the process execution unit 12. In order to calculate the read/write ratio, the statistical information acquisition unit 13 acquires the number of reads and the number of writes in the DRAM 21 from the hardware performance counter when the process is executed by the process execution unit 12. In order to calculate a sequential access degree, the statistical information acquisition unit 13 acquires the number of execution instructions and the number of cache prefetches from the hardware performance counter when the process is executed by the process execution unit 12. As the number of sequential accesses increases, the number of cache prefetches is increased.

A reason why the access frequency is the index related as the characteristic of the PMEM 22 is that a performance difference of the PMEM 22 compared with the DRAM 21 may be acquired based on whether the access frequency is high or low. For example, the lower the access frequency, the smaller the performance difference between the PMEM 22 and the DRAM 21, and the higher the access frequency, the larger the performance difference. Accordingly, it is possible to acquire the performance difference obtained by comparing the PMEM 22 with the DRAM 21 based on whether the access frequency is high or low.

A reason why the read/write ratio is the index related as the characteristic of the PMEM 22 is that the PMEM 22 has a characteristic that read performance is higher than write performance. For example, as the read/write ratio increases, the performance of the PMEM 22 is increased. Accordingly, the performance difference obtained by comparing the PMEM 22 with the DRAM 21 may be acquired based on a value of the read/write ratio.

A reason why the sequential access/random access ratio (sequential access degree) is the index related as the characteristic of the PMEM 22 is that the PMEM 22 has a characteristic that sequential access performance is higher than random access performance. For example, as the degree of sequential access is higher, the performance of the PMEM 22 is higher. Accordingly, it is possible to acquire the performance difference obtained by comparing the PMEM 22 with the DRAM 21 based on a size of the sequential access/random access ratio.

The model application unit 14 applies the statistical information acquired by the statistical information acquisition unit 13 to an overhead model of the PMEM 22. For example, the model application unit 14 applies the access frequency, the read/write ratio, and the sequential access/random access ratio acquired by the statistical information acquisition unit 13 to the following model equation (1) to calculate an overhead PMEM_overhead of the PMEM 22. The overhead of the PMEM 22 is an increment in a processing time in the PMEM 22 with respect to a processing time of the target object in the DRAM 21. “ExetimeDRAM” indicates a time when the process is executed in the DRAM 21 by the process execution unit 12 (an execution time in the DRAM 21). #inst indicates the number of execution instructions. #reads indicates the number of read accesses of the DRAM 21. #writes indicates the number of write accesses of the DRAM 21. #prefetches indicates the number of cache prefetches. Coefficients α, β, and γ are determined by a benchmark test in advance.

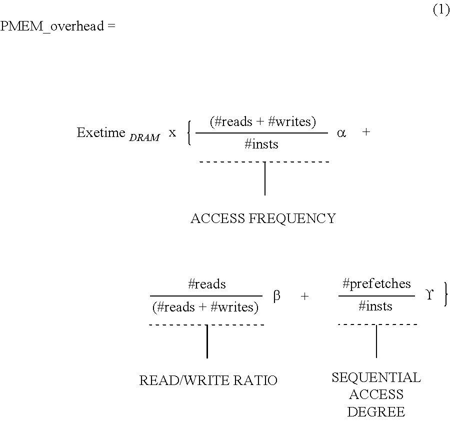

For example, the model application unit 14 acquires an overhead of the second restoration method in which data in the PMEM 22 is re-registered with management metadata to be reused as it is.

The model application unit 14 calculates a processing time in a case where the target object is copied from the PMEM 22 to the DRAM 21, by using a data size of the target object and a throughput of sequential reading from the PMEM 22. The data size of the target object may be acquired from metadata of the target object. The throughput of the sequential reading from the PMEM 22 may be obtained by using a benchmark measured in advance, or by referring to specifications of the PMEM 22. For example, the model application unit 14 acquires an overhead of the first restoration method in which the target object is copied from the PMEM 22 to the DRAM 21 and re-registered.

The model application unit 14 compares the overhead of the first restoration method with the overhead of the second restoration method. In a case where the overhead of the first restoration method is smaller than the overhead of the second restoration method, the model application unit 14 records “0” for identifying the first restoration method in the metadata of the target object to set the restoration method of the target object as the first restoration method. In a case where the overhead of the first restoration method is equal to or greater than the overhead of the second restoration method, the model application unit 14 records “1” for identifying the second restoration method in the metadata of the target object to set the restoration method of the target object as the second restoration method.

[Example of Overhead Comparison]

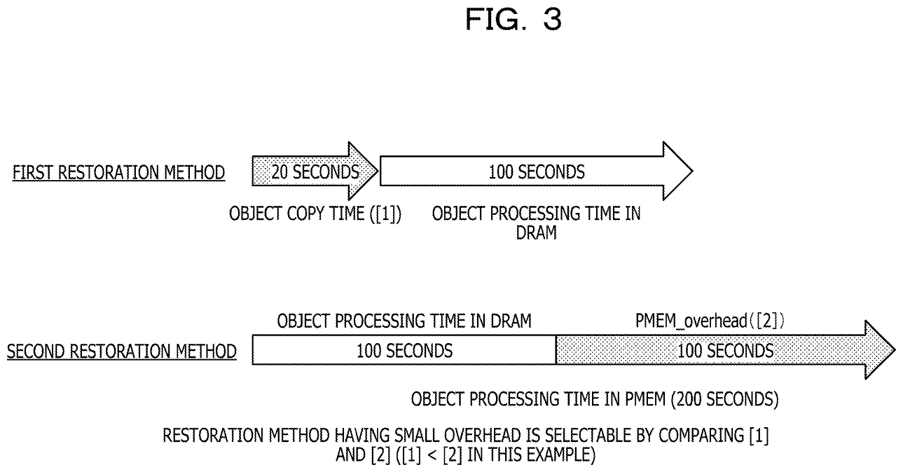

An example of comparison between an overhead of a first restoration method and an overhead of a second restoration method will be described with reference to FIG. 3. FIG. 3 illustrates the example of the overhead comparison.

As illustrated in FIG. 3, in the first restoration method, a processing time after restoration is a time obtained by adding an object copy time ([1]) for copying a target object from the PMEM 22 to the DRAM 21 and an object processing time in the DRAM 21 after the restoration. It is assumed that the object copy time ([1]) is 20 seconds. It is assumed that the object processing time in the DRAM 21 is 100 seconds. Although a processing time for re-registration in the management metadata 210 is also desirable in a strict sense as a time taken for the restoration process, since the second restoration method is also common, the common processing time is omitted.

By contrast, in the second restoration method, since data in the PMEM 22 is reused as it is, the processing time after the restoration is an object processing time in the PMEM 22. For example, PMEM_overhead ([2]) is a time obtained by subtracting the object processing time in the PMEM 22 from the object processing time in the DRAM 21. When the object processing time in the DRAM 21 is 100 seconds as in a case of the first restoration method, and the object processing time in the PMEM 22 is 200 seconds, PMEM_overhead ([2]) is 100 seconds. The processing time for re-registration in the management metadata 210 is omitted as in a case of the first restoration method.

Accordingly, the model application unit 14 may compare the object copy time ([1]) with PMEM_overhead ([2]) when selecting a smaller one of respective overheads of the first restoration method and the second restoration method. Since the object copy time ([1]) is smaller than PMEM_overhead ([2]), the model application unit 14 selects the first restoration method in which the object copy time ([1]) is set as an overhead.

[Description of Memory Management Function]

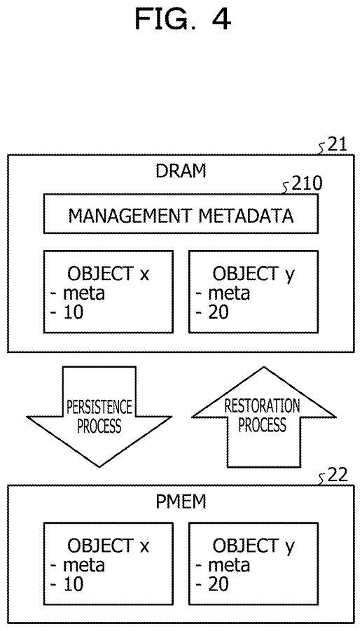

FIG. 4 is a diagram describing a memory management function according to the embodiment. As illustrated in FIG. 4, objects stored in the DRAM 21 and the PMEM 22 are managed together with data and metadata. The memory management function unit 11 manages pieces of data stored the DRAM 21 and in the PMEM 22 as the objects. A memory management function of the memory management function unit 11 is implemented in a backend by the control unit 40. Such a memory management function unit 11 copies a target object from the DRAM 21 to the PMEM 22, and executes a persistence process. Additionally, the memory management function unit 11 executes a restoration process of the target object, based on a restoration method associated with the target object.

[Example of Source Code]

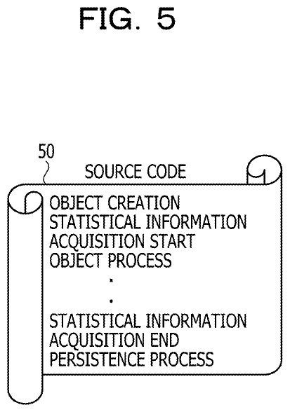

FIG. 5 illustrates an example of a source code. According to the example illustrated in FIG. 5, the source code 50 is provided with an object creation application Interface (API), a statistical information acquisition API, and a persistence process API. The object creation API is an API that creates a target object. The persistence process API is an API that makes the target object persistent. The statistical information acquisition API is an API that acquires statistical information on the target object. A statistical information acquisition start and a statistical information acquisition end are designated in the statistical information acquisition API as sections in which an object process is executed on the target object.

Based on the statistical information acquisition API, the process execution unit 12 executes the object process between the statistical information acquisition start and the statistical information acquisition end on the target object created in accordance with the object creation API. At a time of executing the object process, the statistical information acquisition unit 13 acquires statistical information that is acquirable by hardware. By using the acquired statistical information, the model application unit 14 calculates an overhead of a first restoration method and an overhead of a second restoration method. The model application unit 14 selects a restoration method with a small overhead, and records the selected restoration method in metadata of the target object. The persistence unit 111 executes the persistence process on the target object.

[Example of Persistence Process]

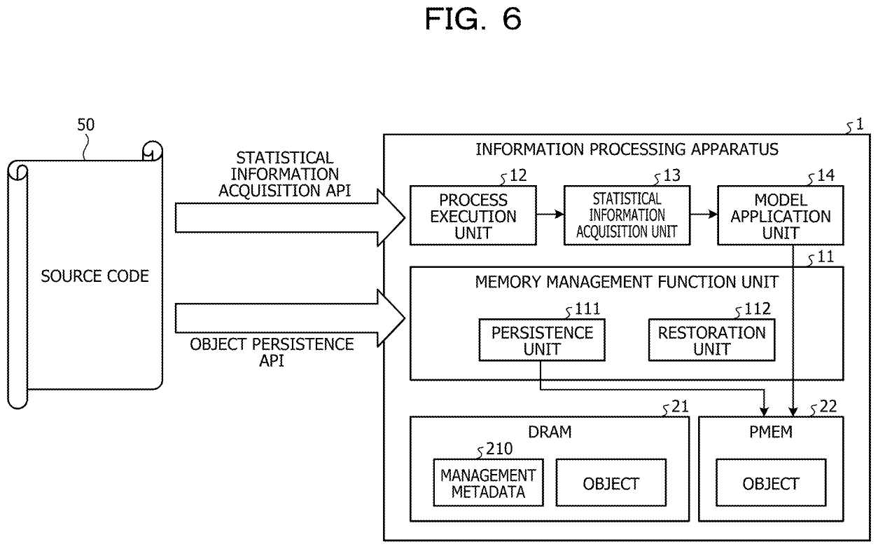

FIG. 6 illustrates an example of a persistence process according to the embodiment. FIG. 6 describes a case where the persistence process includes a process of determining and recording a restoration method for a target object. As illustrated in FIG. 6, the process execution unit 12 executes an object process on the target object in accordance with the statistical information acquisition API from the source code 50. At a time of executing the object process, the statistical information acquisition unit 13 acquires statistical information that is related as a characteristic of the PMEM 22 and acquirable by hardware. For example, the statistical information includes an access frequency, a read/write ratio, and a sequential access/random access ratio.

According to the object persistence API from the source code 50, the persistence unit 111 copies the target object from the DRAM 21 to the PMEM 22, and executes the persistence process.

The model application unit 14 calculates a processing time in a case where the target object is copied from the PMEM 22 to the DRAM 21, by using a data size of the target object and a throughput of sequential reading from the PMEM 22. A calculation result is an overhead of a first restoration method.

The model application unit 14 applies the statistical information acquired by the statistical information acquisition unit 13 to an overhead model (equation (1)) of the PMEM 22. An application result is an overhead of a second restoration method.

The model application unit 14 compares the overhead of the first restoration method with the overhead of the second restoration method, and determines a restoration method having a low overhead. The model application unit 14 records an identifier for identifying the determined restoration method in metadata of the target object in the PMEM 22.

[Example of Restoration Process]

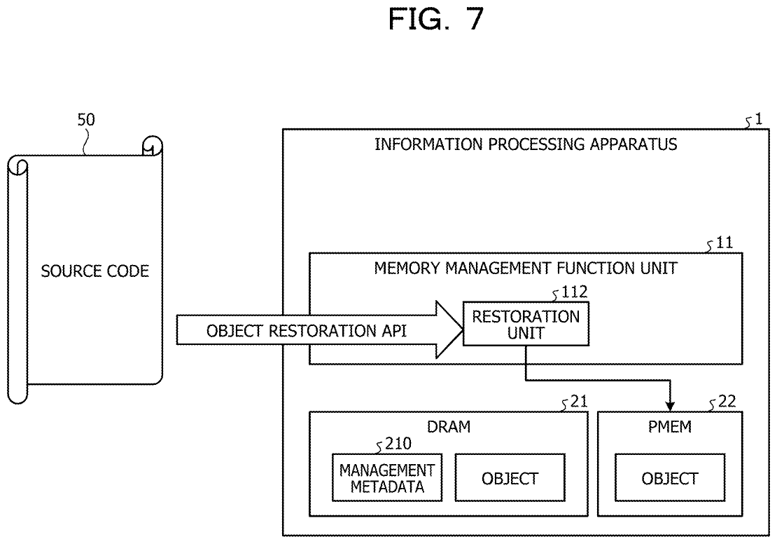

FIG. 7 illustrates an example of a restoration process according to the embodiment. As illustrated in FIG. 7, in accordance with the object restoration API from the source code 50, the restoration unit 112 executes the restoration process by the restoration method determined at the time of the persistence process. For example, the restoration unit 112 executes the restoration process, based on the restoration method recorded in the metadata of the target object.

[Flowchart of Statistical Information Acquisition Process]

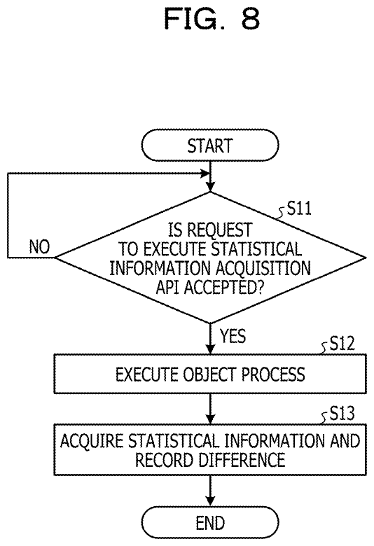

FIG. 8 illustrates an example of a flowchart of a statistical information acquisition process according to the embodiment. As illustrated in FIG. 8, the process execution unit 12 determines whether or not a request to execute the statistical information acquisition API is accepted (step S11). In a case where it is determined that the request to execute the statistical information acquisition API is not accepted (No in step S11), the process execution unit 12 repeats the determination process until the request to execute the statistical information acquisition API is accepted.

By contrast, in a case where it is determined that the request to execute the statistical information acquisition API is accepted (Yes in step S11), the process execution unit 12 executes an object process to acquire statistical information of a target object (step S12).

The statistical information acquisition unit 13 acquires the statistical information, and records a difference (step S13). For example, the statistical information acquisition unit 13 acquires the difference between hardware performance counters to acquire the number of execution instructions, and the number of reads, the number of writes, and the number of cache prefetches in the DRAM 21 between the statistical information acquisition start API and the statistical information acquisition end API. By using the acquired difference, the statistical information acquisition unit 13 acquires the statistical information that is acquirable by hardware. The statistical information acquisition unit 13 temporarily records the acquired statistical information in the DRAM 21. The statistical information acquisition process is completed.

[Flowchart of Persistence Process]

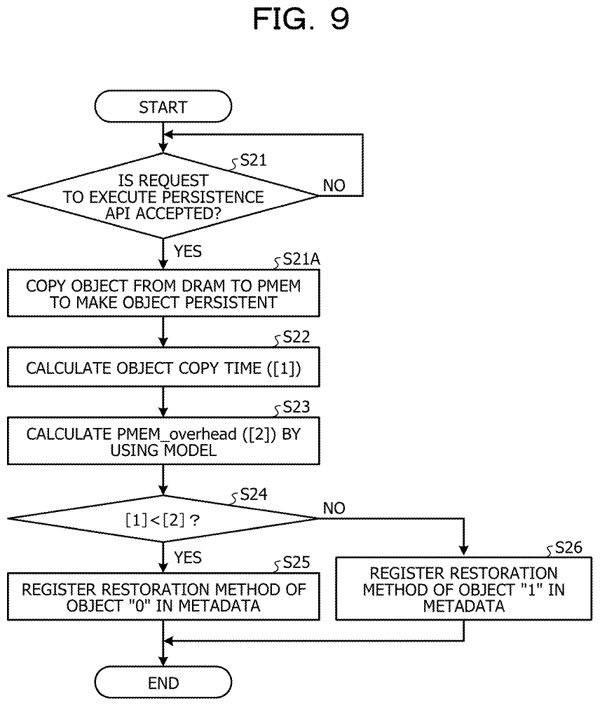

FIG. 9 illustrates an example of a flowchart of a persistence process according to the embodiment. As illustrated in FIG. 9, the persistence unit 111 determines whether or not a request to execute a persistence API is accepted (step S21). In a case where it is determined that the request to execute the persistence API is not accepted (No in step S21), the persistence unit 111 repeats the determination process until the request to execute the persistence API is accepted.

By contrast, in a case where it is determined that the request to execute the persistence API is accepted (Yes in step S21), the persistence unit 111 copies a target object from the DRAM 21 to the PMEM 22 and makes the target object persistent (step S21A).

After that, the model application unit 14 calculates a copy time ([1]) of the target object (step S22). For example, the model application unit 14 calculates the copy time in a case where the target object is copied from the PMEM 22 to the DRAM 21, by using a data size of the target object and a throughput of sequential reading from the PMEM 22. Such a copy time ([1]) is an overhead of a first restoration method.

By using an overhead model (equation (1)) of PMEM 22, the model application unit 14 calculates PMEM_overhead ([2]) (step S23). For example, the model application unit 14 applies the access frequency, the read/write ratio, and the sequential access/random access ratio acquired by the statistical information acquisition process to the model equation (1) to calculate PMEM_overhead indicating an overhead of the PMEM 22. The overhead of the PMEM 22 is an increment in an object processing time in the DRAM 21 with respect to an object processing time in the PMEM 22, and is an overhead of a second restoration method.

The model application unit 14 compares the overhead ([1]) of the first restoration method with the overhead ([2]) of the second restoration method, and determines whether or not [1] is smaller than [2] (step S24). In a case where it is determined that [1] is smaller than [2] (Yes in step S24), the model application unit 14 registers “0” indicating the first restoration method as a restoration method for the target object in metadata of the target object (step S25). The persistence process is completed.

By contrast, in a case where it is determined that [1] is equal to or greater than [2] (No in step S24), the model application unit 14 registers “1” indicating the second restoration method as the restoration method for the target object in the metadata of the target object (step S26). The persistence process is completed.

[Flowchart of Restoration Process]

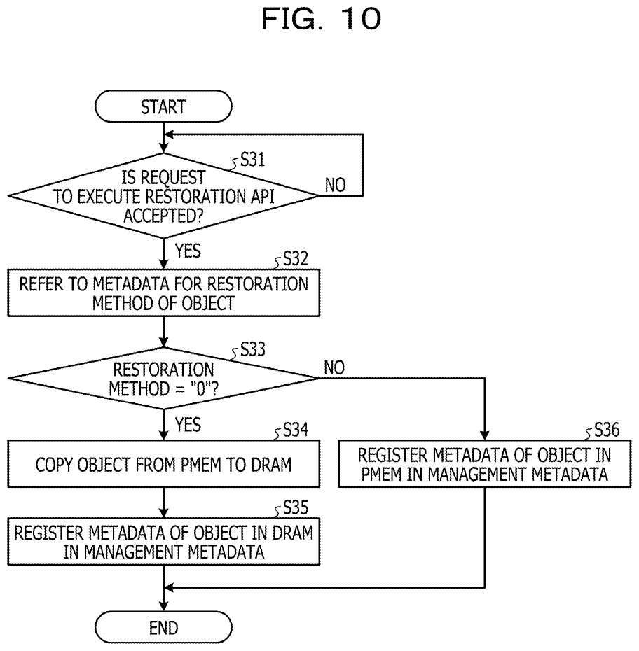

FIG. 10 illustrates an example of a flowchart of a restoration process according to the embodiment. As illustrated in FIG. 10, the restoration unit 112 determines whether or not a request to execute the restoration API is accepted (step S31). In a case where it is determined that the request to execute the restoration API is not accepted (No in step S31), the restoration unit 112 repeats the determination process until the request to execute the restoration API is accepted.

By contrast, in a case where it is determined that the request to execute the restoration API is accepted (Yes in step S31), the restoration unit 112 refers to metadata of a target object for a restoration method for the target object (step S32). The restoration unit 112 determines whether or not the restoration method is “0” indicating a first restoration method (step S33). In a case where it is determined that the restoration method is “0” (Yes in step S33), the restoration unit 112 copies the object from the PMEM 22 to the DRAM 21 restore the object by the first restoration method, and registers the metadata of the target object in the DRAM 21 in the management metadata 210 (steps S34 and S35). The restoration process is completed.

By contrast, in a case where it is determined that the restoration method is not “0” (No in step S33), the restoration unit 112 registers the metadata of the target object in the PMEM 22 in the management metadata 210 to restore the target object by the second restoration method (step S36). The restoration process is completed.

### Effects of Embodiment

According to the above-described embodiment, the information processing apparatus 1 copies data from the DRAM 21 to the PMEM 22 and makes the data persistent. The information processing apparatus 1 estimates an overhead of a first restoration method for restoring data by copying the data from the PMEM 22 to the DRAM 21 and an overhead of a second restoration method using the data in the PMEM 22 as it is, based on statistical information that is acquirable by hardware. At a time of restoring the persistent data, the information processing apparatus 1 restores the data, based on a restoration method having the smaller overhead of the respective estimated overheads of the first restoration method and the second restoration method. According to such a configuration, the information processing apparatus 1 may shorten a processing time after the restoration.

According to the above-described embodiment, the information processing apparatus 1 calculates the processing time in a case where the data are copied from the PMEM 22 to the DRAM 21 by using a throughput of sequential reading and a size of the data, and estimates the calculated processing time as the overhead of the first restoration method. The information processing apparatus 1 acquires statistical information that is acquirable by hardware when predetermined processing is executed on data stored in the DRAM 21. Based on the statistical information that is acquirable by hardware, the information processing apparatus 1 estimates an increment in a case of execution on the PMEM 22, which is the increment with respect to an execution time at the execution, and sets the increment as the overhead of the second restoration method. According to such a configuration, the information processing apparatus 1 calculates a processing time of a restoration process of the first restoration method as the overhead of the first restoration method, and calculates an increment in the PMEM 22 with respect to an execution time when the predetermined processing is executed on the data in the DRAM 21 as the overhead of the second restoration method. Accordingly, the information processing apparatus 1 may estimate the overhead of the first restoration method and the overhead of the second restoration method after restoration including the restoration process and the post-restoration.

In the above-described embodiment, the statistical information that is acquirable by hardware is statistical information indicating an index related as a characteristic of the PMEM 22. Based on the statistical information indicating the index related as the characteristic of the PMEM 22, the information processing apparatus 1 estimates, as the overhead of the second restoration method, the increment with respect to the processing time when the predetermined processing is executed on the data in the DRAM 21. According to such a configuration, the information processing apparatus 1 may estimate the overhead after the restoration by the second restoration method.

In the above-described embodiment, the statistical information that is acquirable by hardware includes an access frequency, a read/write ratio, and a sequential access/random access ratio. Accordingly, the information processing apparatus 1 may estimate the increment in the PMEM 22 with respect to the execution time when the predetermined processing is executed on the data in the DRAM 21.

### [Others]

Each of the components of the control unit 40 of the information processing apparatus 1 illustrated in the drawings is not necessarily physically configured as illustrated in the drawings. For example, specific forms of the separation and integration of each apparatus are not limited to those illustrated in the drawings. The entirety or part of the apparatus may be configured by functionally or physically separating into any units or integrating into any unit in accordance with various loads, usage situations, and the like. For example, the process execution unit 12 and the statistical information acquisition unit 13 may be integrated as one unit. The model application unit 14 may be separated into a first calculation unit that calculates the overhead of the second restoration method by applying the model, a second calculation unit that calculates the overhead of the first restoration method, and a determination unit that determines the restoration method for the target object by comparing the first restoration method with the second restoration method. The storage unit (not illustrated) that stores the management metadata 210 or the like may be coupled to the information processing apparatus 1 via a network as an external apparatus of the information processing apparatus 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a first storage device;
a second storage device having lower performance than performance of the first storage device; and
a control circuit configured to perform processing, the processing including:
copying data from the first storage device to the second storage device to make the data persistent;
estimating, based on statistical information that is acquirable by hardware, an overhead of a first restoration method in which the data is restored by copying the data from the second storage device to the first storage device and an overhead of a second restoration method in which the data in the second storage device is used as it is; and
restoring the data that becomes persistent, based on a restoration method having a smaller overhead of the respective estimated overheads of the first restoration method and the second restoration method, when restoring the data.

2. The information processing apparatus according to claim 1, wherein the estimating of the overhead includes:
calculating, by using a throughput of sequential reading from the second storage device and a size of the data, a processing time in a case where the data is copied from the second storage device to the first storage device, to estimate the calculated processing time as the overhead of the first restoration method;
acquiring the statistical information in response that predetermined processing is executed on the data stored in the first storage device; and
estimating, based on the acquired statistical information, a first increment in a case of execution of the predetermined processing in the second storage device, to use the estimated first increment as a value corresponding to the overhead of the second restoration method, the estimated first increment being an estimated value with respect to an execution time at the time of the execution in the first storage device.

3. The information processing apparatus according to claim 2, wherein
the statistical information includes information indicating an index related as a characteristic of the second storage device, and
the estimating of the increment includes estimating, based on the statistical information indicating the index related as the characteristic of the second storage device, a second increment with respect to the execution time when the predetermined processing is executed on the data in the first storage device, to use the estimated second increment as a value corresponding to the overhead of the second restoration method.

4. The information processing apparatus according to claim 1, wherein
the statistical information includes an access frequency, a read/write ratio, and a sequential access/random access ratio.

5. A computer-implemented method of restoration control in a computer that includes a first storage device and a second storage device having lower performance than performance of the first storage device, the method comprising:
copying data from the first storage device to the second storage device to make the data persistent;
estimating, based on statistical information that is acquirable by hardware, an overhead of a first restoration method in which the data is restored by copying the data from the second storage device to the first storage unit and an overhead of a second restoration method in which the data in the second storage device is used as it is; and
restoring the data that becomes persistent, based on a restoration method having a smaller overhead of the respective estimated overheads of the first restoration method and the second restoration method, when restoring the data.
